(19) United States
(12) Patent Application Publication
(10) Pub. No.: US 2007/0289755 A1
(43) Pub. Date: Dec. 20, 2007

(54) Offset disk attachment for a motor grader

(76) Inventor: Dennis Dowse, Vida, MT (US)

Correspondence Address: JEAN KYLE, P. O. BOX 2274, HAMILTON, MT, 59840-4274, US

(21) Appl. No.: 11/731,987

(22) Filed: Apr. 2, 2007

Related U.S. Application Data
(60) Provisional application No. 60/787,870, filed on Mar. 31, 2006.

(51) Int. Cl. A01B 5/00

(52) U.S. Cl. 172/178

(57) ABSTRACT

An attachment for a motor grader mounts to the grader's ripper bar and uses the grader's auxiliary hydraulics. The attachment has an offset disk unit that is used to manage weed and grass growth in maintaining a roadway. The disk head is deployed on one side of the grader and folds into the grader when not in use.

### REFERENCE TO RELATED APPLICATIONS

This application claims the benefits of U.S. Provisional Application No. 60/787,870, filed Mar. 31, 2006, the disclosure of which is hereby incorporated by reference in its entirety including all figures, tables and drawings.

### BACKGROUND OF THE INVENTION

Motor graders are used to maintain gravel roads in rural counties throughout the United States. In the spring and early summer however road shoulder maintenance becomes difficult with the rapid weed and grass growth. The weed and grass material if not properly processed provides poor material to spread on the road. Attachments for motor graders have been described (U.S. Pat. Nos. 2,036,598; 2,188,435; 5,108,221; 5,197,820; 5,810,097; 6,293,354 B1; 6,394,696 B1; and RE 34,860). These attachments however do not meet the current need. A need therefore remains for an attachment for a motor grader that chops vegetative material preparing it for the road surface.

All patents, patent applications, provisional patent applications and publications referred to or cited herein, are incorporated by reference in their entirety to the extent they are not inconsistent with the teachings of the specification.

### SUMMARY OF THE INVENTION

The attachment of the subject invention comprises an offset disk connected to a motor grader via a mounting means. The mounting means attaches the disk to the ripper of the motor grader requiring no modification of the grader. An extra valve with a float control on the grader runs the hydraulics of the attachment. The attachment is deployed to the left side of the motor grader to disk the grass and gravel windrow as it comes off the grader's mold board. The attachment folds in along side of the motor grader when it is not being used.

### BRIEF DESCRIPTION OF THE DRAWINGS

FIG. 1 is a perspective view of a preferred embodiment of the attachment of the subject invention.

FIG. 2 is top plan view of a preferred embodiment of the attachment of the subject invention.

FIG. 3 is a side elevational view of a preferred embodiment of the attachment of the subject invention.

FIG. 4 is a rear end view of a preferred embodiment of the attachment of the subject invention.

FIG. 5 is an end view of the preferred embodiment of the attachment of the subject invention shown in FIG. 4 in motion.

FIG. 6 is a side elevational view of a preferred embodiment of the mounting means that connect the subject attachment to the ripper bar.

FIG. 7 is a side elevational view of a preferred embodiment of the attachment of the subject invention when not in use folded off the road surface.

### DETAILED DESCRIPTION OF THE INVENTION

The attachment of the subject invention comprises a small offset disk unit and a mounting system that connects the attachment to the ripper of a motor grader. The attachment is mounted on the left side of the motor grader and processes material from the mold board that gathers in windrows along the road so that it can be spread on the road surface. The mounting means folds the attachment off the road surface when the attachment is not in use.

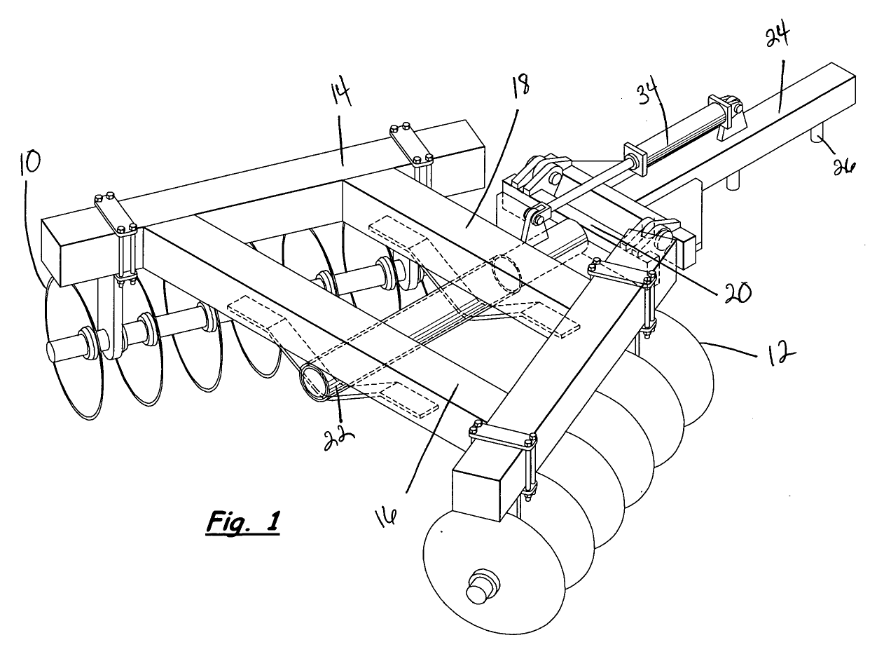

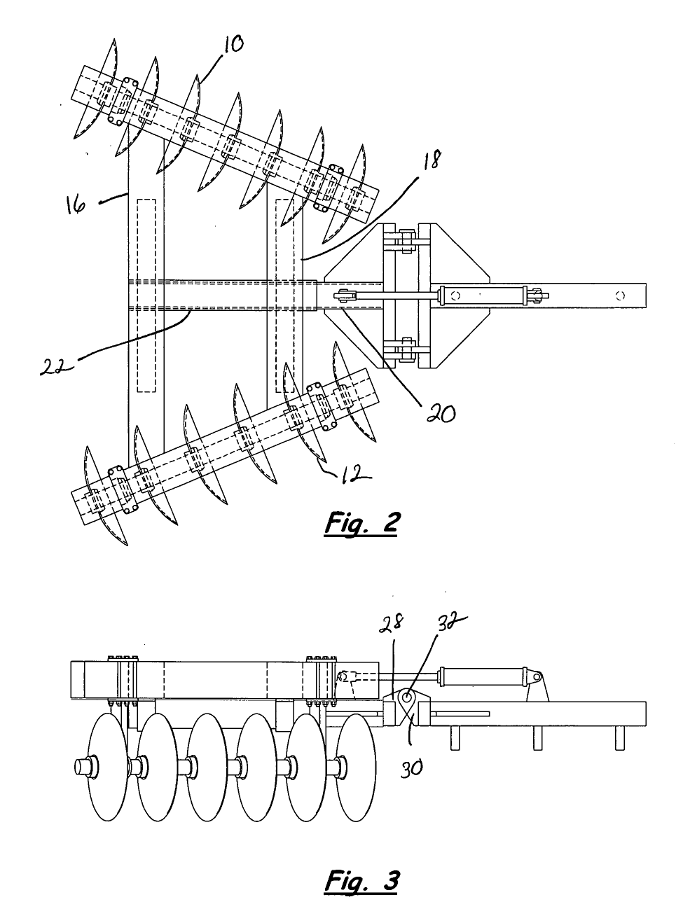

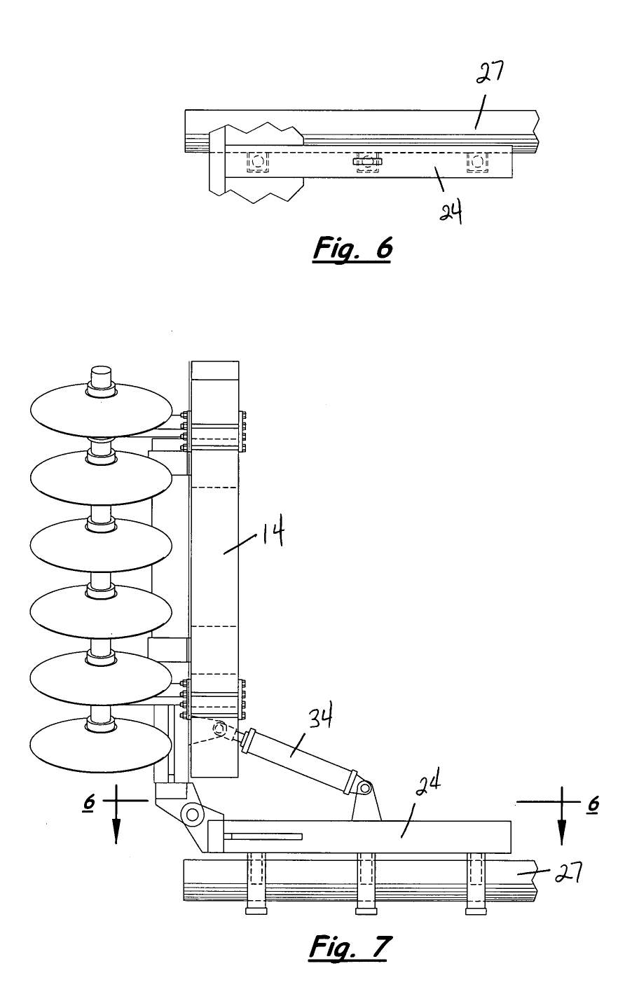

A preferred embodiment of the attachment of the subject invention is shown in the appended figures (FIGS. 1-7). An offset disk unit is hingedly connected to a motor grader ripper bar by a mounting means. The offset disk unit comprises two gangs of disks 10, 12 positioned at approximately a 45° angle along a framework 14 (FIG. 2). The disks are positioned so that the front gang of disk blades 10 move graded material one way and the rear gang of disk blades 12 move the graded material in the opposite direction. In a preferred embodiment, the front gang has 6-24″ disk blades and the rear gang has 7-24″ disk blades. The disk gangs in this embodiment have 10″ spools and cast housing sealed bearings. The shaft holding the disk blades and spools together depends on the center hole of the disk blades and the inside diameter of sealed bearings, 1½″ to 2″ is recommended. Positioning beams 16, 18 of the framework 14 hold the front and rear gangs together, the narrowest part of gangs should preferably be no less than 2 feet apart. In the exemplified embodiment, disk size and spacing were chosen to suit road conditions in eastern Montana. The disks and framework of the subject attachment can become fouled with road material and vegetation. One skilled in the art would be able to determine proper disk size and separation for a particular road condition. Additionally, frame ends should be closed or capped to prevent debris from sticking in the framework.

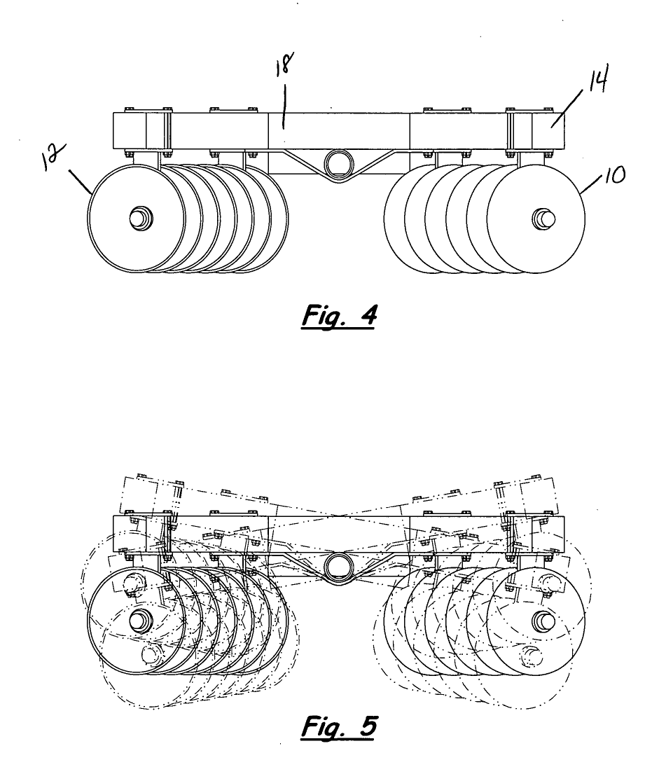

The offset disk unit is mounted so it can float freely along the road's surface. The exemplified embodiment shows a simple system to allow the offset disk unit to oscillate (FIG. 5). A tube 22 affixed to the bottom of positioning beams 16 and 18 of framework 14 receives the base of T-shaped member 20. The tube 22 is supported by an underlaying brace (FIG. 4). The T-shaped member 20 moves within the tube 22 allowing the disk unit to float over the road surface.

A mounting means attaches the offset disk unit to the ripper of a motor grader. In the exemplified embodiment, a T-shaped member 24 mounts the disk unit to the ripper bar. The base of braced T-shaped member 24 has shanks 26 which are inserted and secured in holes in the bar of the ripper 27. Preferably, two shanks of the attachment are placed in the outermost and center holes of the bar. Ripper tines can therefore be placed in unused holes on the bar when the attachment is installed on the motor grader.

The offset disk unit is preferably hingedly attached to the ripper bar so that the disk unit can be lifted of the road surface when not in use (FIG. 7). In a particularly preferred embodiment, the hinge is created by ears on the offset disk unit and the ripper mounting means pinned together (FIG. 2). Ears 28 on the end of T-shaped member 20 engage ears 30 on the end of T-shaped member 24. Pins 32 are threaded through apertures in the ears to create the hinge. The exemplified hinge member is preferred because it was less likely to foul under condition in eastern Montana. One skilled in the art would realize however that other hinge mens could be used on the subject attachment. For example, hinges created from bands and sleeves were found to foul in eastern Montana but may be suitable for areas with different vegetation, soil and road materials.

To use the attachment of the subject invention, the ripper is lowered to about 2 feet off the ground. A cylinder 34 is used to keep the disk horizontal with the top of road. If the top of road is hard, then the disk cylinder can be run in a float position. The disk cylinder is powered by an extra hydraulic valve on the motor grader that has a float position. Run the blade along the right side of road. As the material slides off the mold board it passes by the left side of motor grader where the disk unit of the subject attachment processes the bladed road material into a windrow. Then, driving in the opposite direction, run the blade along the other side of road. Combine both processed windrows to the left side of machine where the material will be processed again by the disk. The processed material can be spread over the top of the road or the operator can determine if more material processing is necessary.

It is understood that the foregoing examples are merely illustrative of the present invention. Certain modifications of the articles and/or methods may be made and still achieve the objectives of the invention. Such modifications are contemplated as within the scope of the claimed invention.

1. An attachment for a motor grader comprising:
an offset disk unit; and
a mounting means to mount the attachment to a ripper bar of the motor grader.

2. The attachment of claim 1, wherein said offset disk unit is connected to allow said offset disk unit to oscillate along the surface of a road.

3. The attachment of claim 1, wherein said offset disk unit comprises two gangs of disks positioned on a framework that positions the gangs at an angle of about 45 degrees.

4. The attachment of claim 3, wherein said gangs of disks are positioned on said framework to work in opposition of each other.

5. The attachment of claim 3, wherein said gangs are at least two feet apart.

6. The attachment of claim 1, wherein said offset disk unit comprises two gangs of disks positioned on a framework that positions the gangs at an angle of about 45 degrees, wherein said gangs of disks are positioned on said framework to work in opposition of each other, wherein said gangs are at least two feet apart; and wherein a tube is connected to said framework and receives a T-shaped member connected to said mounting means, the T-shaped member moving within the tube allowing said offset disk unit to oscillate along the surface of a road.

7. The attachment of claim 1, wherein said mounting means comprises a T-shaped member, the base of the T-shaped member comprising at least two shanks to insert into and secure to a bar of the ripper of said motor grader.

8. The attachment of claim 1, wherein said mounting means comprises a hinge to allow said offset disk unit to be removed from the surface of a road when said attachment is not being used.

9. An attachment for a motor grader comprising:
an offset disk unit, wherein said offset disk unit comprises two gangs of disks positioned on a framework that positions the gangs at an angle of about 45 degrees, wherein said gangs of disks are positioned on said framework to work in opposition of each other, wherein said gangs are at least two feet apart, and wherein a tube is connected to said framework and receives a T-shaped member connected to said mounting means, the T-shaped member moving within the tube allowing said offset disk unit to oscillate along the surface of a road; and
a mounting means mounting the attachment to a ripper bar of the motor grader, the mounting means comprising a T-shaped member, the base of the T-shaped member comprising at least two shanks to insert into and secure to the bar of the ripper of the motor grader, and wherein said mounting means further comprises a hinge to allow the offset disk unit to be removed from the surface of a road when the attachment is not being used.
